(19) United States
(12) Patent Application Publication
(10) Pub. No.: US 2010/0053941 A1
(43) Pub. Date: Mar. 4, 2010

(54) Security light purse

(76) Inventor: Cherl Ann Ibison, Visalia, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 12/231,542

(22) Filed: Sep. 3, 2008

(51) Int. Cl. F21V 33/00

(52) U.S. Cl. 362/155; 362/156

(57) ABSTRACT

A security light purse having a purse light disposed in an interior compartment of the purse body so as to light up the compartment to enable the user to more easily find one or more objects inside the purse. In a preferred embodiment, the purse light comprises a flexible light panel having a plurality of LEDs or other light sources disposed about the periphery of the light panel. The light sources connect to batteries disposed inside a battery compartment at the bottom of the purse. A recharge port facilitates recharging the batteries. The purse can have an alarm unit operatively connected to the purse's handles such that the alarm is activated when the handles are pulled from the purse body during an attempted purse snatching. The preferred purse also has a safety device mechanism for securing a personal safety device, such as mace, to the purse for ready use.

### CROSS-REFERENCE TO RELATED APPLICATIONS

None.

### STATEMENT REGARDING FEDERALLY SPONSORED RESEARCH

Not Applicable.

### BACKGROUND OF THE INVENTION

A. Field of the Invention

The field of the present invention relates generally to devices and systems for improving the functionality and use of purses, handbags and the like. In particular, the present invention relates to an improved purse and devices and systems for use with a purse that facilitate ease of use of the purse and improve the safety of the person utilizing the purse. More particularly, the present invention relates to such purses that have a light for the interior of the purse, initiate an audible alarm in case of theft of the purse and provide a mechanism for self-defense. The present invention also relates to devices and systems that improve a purse to provide one or more of such features.

B. Background

Most women carry the items they utilize on a regular basis, including a wallet, keys, cell phones, make-up and like objects in a purse or handbag that they carry with them. While the carrying and use of conventional purses are generally associated with women, many people of both sexes carry purse-like objects, including but not limited to handbags, waist packs and briefcases, which for purposes of the present disclosure are collectively referred to as “purses”. Such purses generally comprise a purse body having two side walls and two end walls that form an interior compartment in which the user's objects are stored. Typically, the compartment of such purses are configured to open from the top, while remaining closed at the bottom, to allow the user to access the objects in the purse. A handle is attached to the purse and utilized to allow the user to carry the purse. The purse handle may be relatively short for the user to carry the purse with his or her hand or it may be longer to allow the user to carry the purse with the handle draped over one of his or her shoulders. While the purse handle may take many different forms, one common purse handle comprises a strap member that extends from at or near one end of the purse body to the opposite end of the purse body and is sized so the user carries the purse with the body portion of the purse hanging generally below the user's hand.

One well known problem with the effective use of purses, particularly those which are configured with closed walls and a substantially open interior compartment that create a “cavernous” type of configuration, is the ability to easily access and find the contents which are stored in the interior compartment. Often, the various objects which make up the contents of the purse are at least somewhat loosely placed inside the purse such that the user must “dig” around inside the purse to locate the object he or she needs, particularly relatively small objects such as keys, make-up and the like. The ability to locate the desired object from among the other objects carried in the purse can be somewhat limited in dark or even generally low light conditions, such at night, in the evening or at locations where the ambient light is relatively low (i.e., movie theaters, some restrooms, in a vehicle and various other interior locations). Generally, the ability to easily locate an object in a purse is merely frustrating and inconvenient. At other times, however, the inability to easily and quickly locate the desired object can be somewhat dangerous for the user of the purse. For instance, when the user is at his or her car, residence or hotel, the inability to find the key to unlock the door can leave the user standing outside the door of the vehicle or building searching for the appropriate key while he or she is somewhat vulnerable. Even when the key is found, often the darkness of the area makes it difficult to place the key into the keyhole and open the door.

Those skilled in the art recognize the problem with locating items in a purse under low or no light conditions and, as a result, a number of prior art devices have been developed. Generally, prior art lighting devices or systems for purses are too bulky, thereby utilizing too much of the somewhat limited space inside the purse, and have generally high power requirements, requiring too many batteries and/or excessive replacement or recharge of the batteries. A number of prior art patents have also attempted to address potential solutions to this problem. For instance, U.S. Pat. No. 5,005,111 to Teal describes a purse light assembly that comprises a case having a light element on the front surface with a hood to direct the light, a power source and a horn element that emits an audible signal if the purse is left open for longer than a predetermined amount of time. U.S. Pat. No. 5,934,790 to Quintana, et al. describes a purse light system that includes a lamp circuit that activates a lamp detachably mounted in the purse, with the lamp disposed in a light housing having a transparent angled lense and a mirror reflector to reflect the light from the lamp through the lens. U.S. Pat. No. 4,742,438 to King describes a purse light comprising a light bulb and power supply inside a housing that is mounted to a bracket which is permanently mounted inside the purse. U.S. Pat. No. 3,792,652 to Zeeb describes an automatic purse light having a tubular frame with the light source and battery in the frame and a switch on the outside of the frame that automatically activates the light when the purse is open and deactivates the light when the purse is closed.

Another relatively common problem with purses is theft of the purse by grabbing it while being carried by the user, typically by yanking the purse out of the user's hand. A common scenario for such crimes is that the user is walking along the street, up/down stairs or entering an elevator, bus or other moveable location, the criminal snatches the purse out of the user's grip, often by pulling on the strap/handle as it hangs down from the user's hand, and then the criminal runs away with the purse. Usually, the user is left standing there without his or her purse while the criminal is running away with the purse in his or her hand to disappear into a crowd. Naturally, such theft is disturbing to the victim in that it results in loss of money, identity and the other contents of the purse and requires the user to invest time in cancelling the credit cards and then replacing those cards, driver's license and any other materials that must be replaced.

The problems associated with the theft of a purse are well known in the prior art. Several prior art patents have attempted to address this problem. For instance, U.S. Pat. No. 6,133,831 to Kyles describes a purse alarm system comprising purse straps that are attached to the purse with detachable pull pins which detach from the purse if the purse is snatched to activate an electronic system that sounds an audible alarm. U.S. Pat. No. 3,701,140 to Dixon describes a purse theft alarm comprising an alarm unit which is connected to a flexible handle such that when the handle is pulled sharply a switch activates the audible alarm. U.S. Pat. No. 3,851,326 to Costa describes a purse alarm comprising an alarm unit that has one end of a flexible cord operatively attached to the alarm and the other end attached to the user's wrist such that grabbing the purse from the user separates the cord and activates the alarm.

In addition to snatched purse-activated alarms, a number of other personal alarm type systems are commercially available. Typically, such alarms comprise an alarm case having an audible alarm that is activated by manually pulling a pin, cord or other mechanism from the alarm case. An example of one such personal alarm is the personal attack alarm or PAAL from Quorum. In one version, its sports or workout version, the alarm has a belt clip that clips on to the user's clothes and a pull pin that is pulled to activate a very high pitch squeal and then placed back in to deactivate the alarm. Other types of personal alarm systems are also commercially available. Although these personal alarm generally work well for their intended purposes, one limitation to such alarm systems is that they must be activated by the user and, as such, must be readily accessible to the user. Carrying such an alarm in a purse will not help the user if his or her purse is stolen.

Many people who carry a purse also carry one or more personal safety devices either inside the purse or on their person, typically in a pocket of their clothes, as a form of self-protection in case they are accosted or otherwise attacked by someone. For purposes of the present disclosure, examples of such personal safety devises include portable, easily carried spray containers of mace, pepper spray or other chemical irritant, personal-type stun guns or “zappers” and small weapons such as a knife or a gun. As well known in the art, a variety of other devices and systems are also utilized as personal safety devices. One well known problem with such personal safety devices is where to carry the device such that it is easily accessible in case it is needed for self-defense, without having to carry the device in the user's hand the whole time he or she is in a potentially threatening area. When carrying a purse, the personal safety device is typically carried inside the purse. Unfortunately, the device is generally mixed in with the various other contents of the user's purse, making its quick retrieval from the purse during a potential threat somewhat difficult and unlikely, thereby rendering the device generally ineffective to assist the user when he or she needs it the most.

Although the prior art generally describes purse lighting systems, purse and personal alarm systems and personal safety devices, the prior art does not describe a purse which contains an improved lighting device and/or various combinations of such devices and systems. What is needed, therefore, is an improved purse lighting system that more effectively and efficiently lights the interior compartment of a purse and a purse that combines the benefits of a lighted purse, an automatic alarm if the purse is snatched from the user and an improved mechanism for carrying and accessing a personal safety device. The preferred lighting device for a purse should be configured to automatically light the interior of the purse when it is opened, turn off the light when the purse is closed and power the light in a manner that utilizes less energy than existing purse lighting devices. Preferably, the lighting device would be adaptable to being made to be either integral with the purse, such as fixedly attached thereto, or configured as a separate component that can be moved from one purse to another. In addition, it is preferred that the purse light be configured such that it can be utilized to direct light away from the purse, such as to a keyhole on a vehicle door lock or a door knob on a building door.

### SUMMARY OF THE INVENTION

The security light purse of the present invention solves the problems and provides the benefits identified above. That is to say, the present invention discloses a security light purse that, in a preferred embodiment, combines the features of a lighted purse, an audible alarm system and a mechanism to more effectively carry a personal safety device. The improved lighting device for the purse of the present invention more effectively and efficiently lights the interior compartment of the purse so the user can more easily and quickly find one or more objects inside the purse and does so with less energy requirements than presently available purse lighting systems. In one embodiment, the lighting device is integral with the purse or fixedly attached in the purse. In another embodiment, the lighting device is a separate device that is easily moved from one purse to another. In the embodiment of the security purse, the straps are removably attached to the purse such that if the purse is snatched out of the user's hand the separation of the straps will automatically activate an audible alarm that identifies the purse as being stolen. The user can also activate the purse alarm himself or herself by pulling the strap from the purse body if he or she feels threatened and needs help. The preferred security purse also has a personal safety device carrying pouch that securely attaches to a side of the purse with an extendable and retractable pull cord that allows the user to pull the personal safety device away from the purse where he or she can effectively and confidently direct it towards the assailant who threatens him or her. The security light purse of the present invention is adaptable to a wide variety of different sizes and styles of purses.

In a primary embodiment of the present invention, the security light purse comprises a purse body configured with a plurality of walls that define an interior compartment inside the purse body, an open/close mechanism, such as a clasp, on the purse body that is configured to selectively place the purse body in a closed position closing the interior compartment or an open position allowing access to the interior compartment and a purse light disposed inside the interior compartment so as to direct light inside the compartment to assist the user with finding and retrieving one or more objects from inside the compartment. In a preferred embodiment, the improved purse light comprises a light panel having a plurality of sources of light disposed thereon. In one configuration, the sources of lights are LEDs that are positioned inside a tubular section of the light panel that extends generally around the periphery of the light panel. The sources of light are connected to a source of electrical power, which in the preferred embodiment is one or more rechargeable batteries. The batteries are connected to the open/close mechanism such that opening the interior compartment causes the light panel to emit light and closing the interior compartment turns off the light. In the preferred embodiment the light panel is made from a flexible plastic material so that it may be bent or otherwise shaped to generally match the shape of one of the walls of the purse body. Preferably, the batteries are disposed in a battery compartment located at or near the bottom of the purse body. The purse light can be configured to be integral with the purse, fixedly attached to the purse body or removable from the purse body. In the latter configuration, the purse light has its own battery so that it can be moved from one purse to another and more easily directed at an object that is located outside of the purse, such as a keyhole on a vehicle or building door.

In the preferred embodiment of the security light purse, the purse also comprises an alarm unit that activates a high pitched, loud alarm if someone attempts to snatch the purse and a safety device mechanism configured to hold a personal safety device on the purse in position for ready use. In the preferred embodiment, the alarm unit is disposed inside an alarm compartment located at or near the bottom of the purse and the alarm unit is connected to the same batteries used to power the purse light. Preferably, the alarm is activated by an activating mechanism associated with the purse handle such that the alarm is set off by the separation of one or more ends of the purse handle from the purse body. The activating mechanism is configured to activate when the handle, which may be a strap member, is pulled with sufficient force to separate from the purse body, whether due to an attempted purse snatch or by the user himself or herself if the user feels threatened. The safety device mechanism of the preferred embodiment comprises a pouch unit that is secured in place against a wall of the purse body by a retractable securing mechanism having a wire member that is pulled outward when use of the personal safety device is needed and which retracts inward when the device is not in use. A flap can be used to cover and protect the safety device mechanism. Alternatively, the safety device mechanism is configured to hold the personal safety device inside the purse.

Accordingly, one of the primary aspects of the present invention is to provide a security light purse that has the advantages discussed above and overcomes the disadvantages and limitations associated with presently available purses and lighting and/or alarm systems utilized with such purses.

It is also an important aspect of the present invention to provide a security light purse that combines the features of purse light for effectively lighting the interior compartment of the purse, an audible alarm that automatically sounds when the strap is disconnected and a mechanism for carrying a personal safety device in a manner that allows effective use thereof.

It is also an important aspect of the present invention to provide a security light purse that has a purse light that more effectively and efficiently lights the interior of the purse and which can be utilized to direct light away from the purse to illuminate an area, such as a keyhole, desired by the user.

It is also an important aspect of the present invention to provide a purse light that can be adapted to be integrally formed with the purse, fixedly attached to the purse or removably placed in the purse.

Another important aspect of the present invention is to provide a security light purse that is adaptable for a wide variety of different sizes, styles and types of purses which can be utilized by both men and women.

Yet another important aspect of the present invention is to provide a security light purse that is relatively inexpensive to manufacture so that it can be readily available to a wide variety of users.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a side perspective view of a security light purse that is configured according to a preferred embodiment of the present invention shown in the closed position;

FIG. 2 is a side perspective view of the security light purse of FIG. 1 shown in an open position;

FIG. 3 is a side perspective view of the security light purse of FIG. 1 shown with the first side wall removed to show the interior compartment of the purse body with the purse light, alarm and power supply shown therein;

FIG. 4 is a side view of the purse light utilized in the security light purse of FIGS. 2 and 3;

FIG. 5 is an isolated side view of the second end of the strap member showing the activating mechanism utilized with the security light purse of FIG. 1;

FIG. 6 is a side perspective view of the security light purse of FIG. 1 showing the personal safety device pulled from the purse and in use;

FIG. 7 is a side perspective view of an alternative embodiment of the security light purse of the present invention showing use of a flap to cover the safety device mechanism and personal safety device;

FIG. 8 is a side perspective view of an alternative embodiment of the security light purse of the present invention showing the safety device mechanism and personal safety device disposed inside a pocket inside the purse;

FIG. 9 is a side perspective view of an alternative embodiment of the security light purse of the present invention showing the purse in the open position and the safety device mechanism and personal safety device disposed inside a pocket located on an end wall inside the purse; and

FIG. 10 is a side perspective view of the embodiment of FIG. 9 showing the purse in the closed position.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures and drawings are merely illustrative of one or more of the preferred embodiments and, as such, represent one or more ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein are directed to a certain type of purse made out of conventional materials and configured in a conventional manner, those skilled in the art will readily understand that this is merely for purposes of simplifying the present disclosure and that the present invention is not so limited.

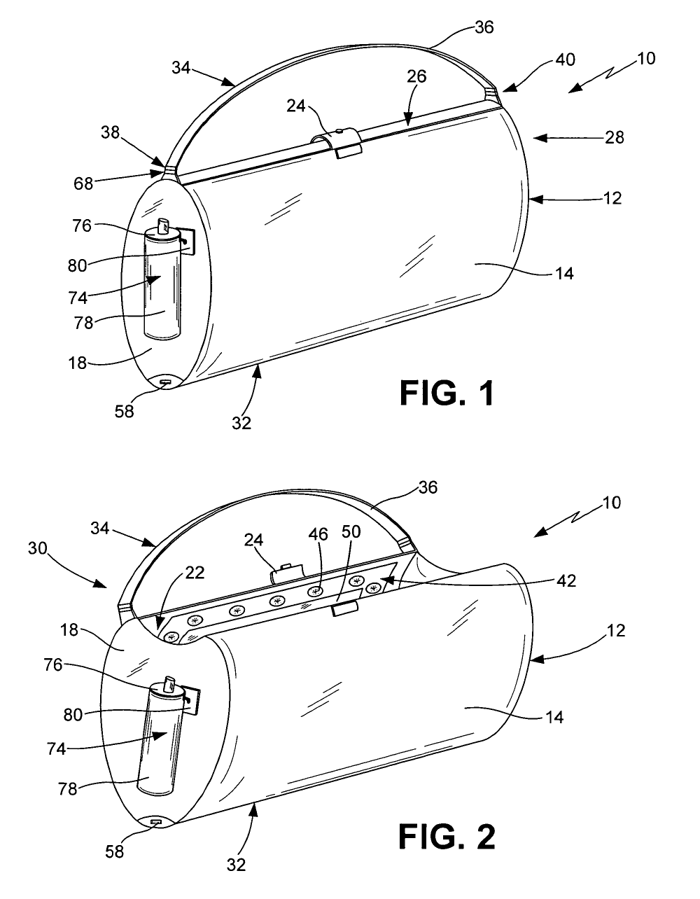

The security light purse that is manufactured out of the various components and configured pursuant to the preferred embodiments of the present invention is shown generally as 10 in the figures. As best shown in FIGS. 1 through 3, security light purse 10 generally comprises a purse body 12 that, in a typical configuration, has a first side wall 14, second side wall 16, first end wall 18 and second end wall 20 that define an interior compartment 22 inside body 12. A clasp mechanism 24 at the top 26 of purse 10 is utilized to secure the sides 14/16 in a closed position 28 to secure the contents of purse 10 inside compartment 22 and allow the user to place purse 10 in an open position 30 so that he or she may add or remove one or more of the objects from inside compartment 22. In the closed position 28, the top 10 of purse 10 defines the top wall of compartment 22. The bottom 32 of the purse 10 is closed to form the bottom wall of compartment 22. Purse 10 has a handle 34 that is configured for the user to carry purse 10. In the configuration of FIGS. 1 through 3, handle 34 comprises a strap member 36. Depending on the length of strap member 36, the user can carry purse 10 either by grasping strap member 36 with his or her hand or by placing the strap member 36 over his or her shoulder. In the embodiment shown, the first end 38 of strap member 36 attaches to purse body 12 at or near first end wall 18 and the second end 40 of strap member 36 attaches to purse body 12 at or near second end wall 20. Various other configurations for purse 12 are well known and readily adaptable to the present invention. For instance, the purse body 12 can have a different size and/or configuration than that shown, the purse open/close mechanism can be different than clasp 24 and the handle 34 can be configured to be more of a briefcase-type handle that is primarily disposed at or near the middle of purse 10 instead of extending between first 18 and second 20 end walls. Purse 10 of the present invention can be made from a wide variety of different materials, include pockets and/or dividers inside compartment 22 and have one or more pockets on the outer surfaces of side walls 14/16 and/or end walls 18/20 for storage of items such as glasses, cellular phones and keys.

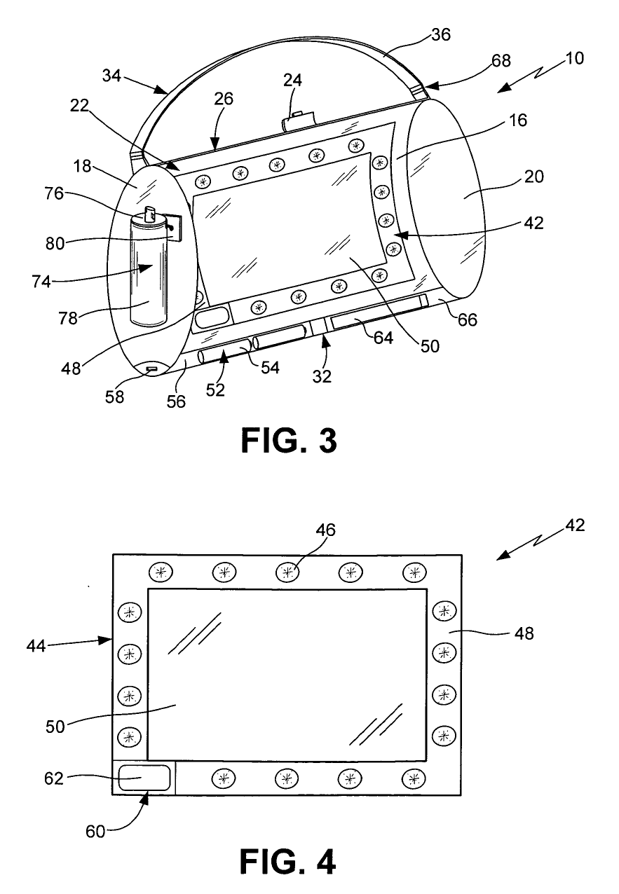

Purse 10 of the present invention includes an improved purse light 42 that is disposed inside of compartment 22 to direct light into compartment 22 so the user can more effectively and efficiently find and remove the contents of purse 10. As best shown in FIGS. 3 and 4, in the preferred embodiment the purse light 42 comprises a generally planar light panel 44 having a plurality of light sources 46 disposed generally around the periphery of light panel 44. In the embodiment shown, the light sources 46 comprise LEDs that are disposed in a generally tubular section 48 of light panel 44 around the interior section 50 of light panel 44. Preferably, light panel 44 is sufficiently flexible so it may be easily shaped in the same general shape as interior compartment 22 and then placed along one of the side walls 14/16 of purse body 12, as shown in FIG. 3. In the preferred embodiment of purse light 42, the center section 50 of light panel 44 is blank, comprising just the material from which light panel 44 is made. In an alternative embodiment, the center section 50 comprises a reflective surfaces so the user can utilize purse light 42 as a mirror for applying makeup, removing debris from an eye or like tasks. In a preferred embodiment, the light panel 44 is made out of a plastic that is sufficiently elastic that it may be curved to the shape of first 14 or second 16 side wall. LEDs are the preferred light source 46 for purse light 42 due to the generally bright light they emit with relatively low power usage (compared to light bulbs and the like). In an alternative embodiment, the light source 46 may be a fiber optic cable that is disposed about the periphery of light panel 44. In yet another embodiment, the light source 46, whether LEDs or other light sources, can be disposed more randomly about light panel 44, such as in center section 50, instead of just being disposed about the periphery thereof. As discussed in more detail below, purse light 42 of the present invention can be manufactured integral with purse 10, fixedly attached to the inside of the interior compartment 22 or removably disposed inside of compartment 22.

In the embodiment shown in FIG. 3, purse light 42 is attached to a source of electrical power 52, such as one or more batteries 54 disposed inside battery compartment 56, which may be located inside purse 10 at or near the bottom 32 of purse body 12. In a typical configuration, appropriate electrical wires (not shown) interconnect the source of electrical power 52 and purse light 42. Purse light 42 and source of electrical power 52 are operatively connected to the open/close mechanism 24 such that when the user places purse 10 in the open position 30 the source of electrical power 52 will energize the light sources 42 to emit light therefrom inside the interior compartment 22 and when the compartment 22 is closed the light sources 46 will be turned off to conserve the life of the LEDs and the power of batteries 54. If desired, purse 10 can include a recharge port 58 that is configured to receive a power cord (not shown) to interconnect one or more rechargeable batteries 54 with a wall outlet or the like so the batteries 54 may be recharged when the purse 10 is not in use. The user should have access to battery compartment 56 so that he or she may replace the batteries 54 as needed or desired.

In an embodiment where purse 10 comprises the purse light 42 integrally formed with purse 10 or purse light 42 fixedly secured inside the interior compartment 22, it is only necessary that the wires or other connectors are sized to interconnect the appropriate components. In an alternative embodiment, the wires connected to purse light 42 are of sufficient length that the user can pull the purse light 42 at least partially out of compartment 22 so that he or she may direct the light from the light sources 46 to an object outside of purse 10, such as a keyhole located on a car, house or hotel door so the user can more quickly use his or her key to open the door. The purse light 42 and wires which connect the purse light 42 to the batteries 54 and open/close mechanism 24 can be such that light panel 44 remains tethered to purse 10 even when it is pulled out of interior compartment 22. In another embodiment, purse light 42 can be configured to disconnect from purse 10. In this embodiment, purse light 42 should include its own panel power source 60, shown in FIG. 4, so the user can utilize the purse light 42 as a light source when it is disconnected from purse 10. Preferably, the panel power source 60 is a small rechargeable battery 62 that is connected to the recharge port 58 so it is recharged when the recharge port 58 is connected to a wall outlet or the like. In yet another embodiment, the purse light 42 is a separate component that is not connected to purse 10 at all. In this embodiment, the purse light 42 can be easily used outside of purse 10 and moved from one purse to another. This has the advantage of allowing the user to have a single purse light 42 that is useable with different purses 10.

The preferred embodiment of the purse 10 of the present invention also includes an alarm unit 64 that is disposed inside an alarm compartment 66 at or near the bottom 32 of purse body 12, as best shown in FIG. 3. Alarm unit 64 is connected to and powered by the source of electrical power 52, such as batteries 54. In the embodiment where purse light 42 is connected to batteries 54, both the alarm unit 64 and purse light 42 can connect to and be powered by batteries 54. In the embodiment where purse light 42 is solely powered by its own power source 60, the alarm unit 64 can solely connect to the batteries 54. Alternatively, alarm unit 64 can have its own internal source of power which, preferably, connect to the recharge port 58 so they may be recharged when the purse 10 is not in use. Alarm unit 64 should be of the type that emits a loud shrill audible alarm so it will be obvious to anyone nearby that the person having or running with purse 10 with the alarm unit 64 activated does not belong with the purse 10. Preferably, alarm unit 64 has a discontinue or off switch that turns the alarm off if it is accidently activated or when the owner of purse 10 retrieves the purse 10 from the would-be robber. It is preferred that any such discontinue/off switch should be located in the purse 10 in location that would not be readily obvious to the robber such that he or she could easily turn off alarm unit 64 while in running with or otherwise possessing purse 10.

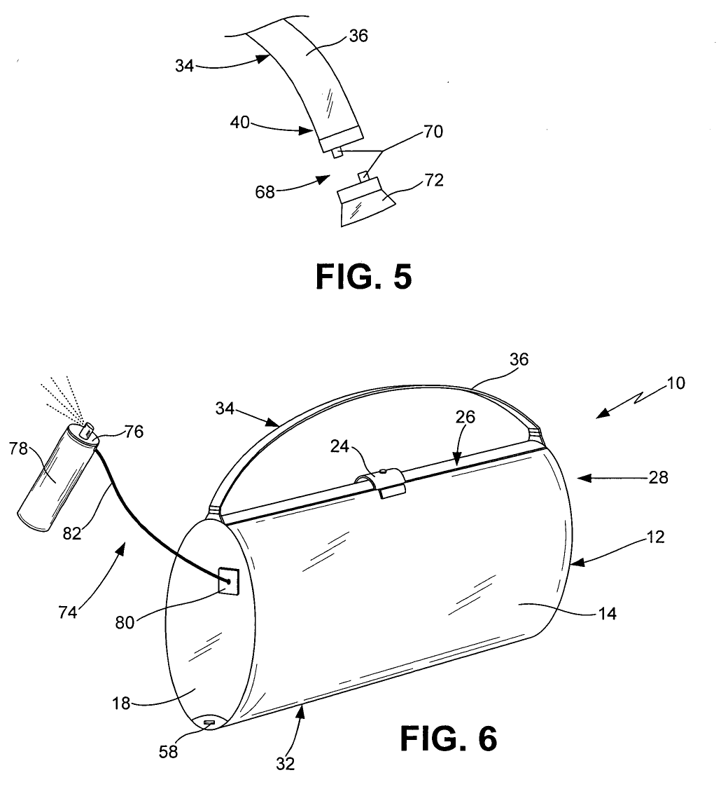

Although purse 10 can have an on/off switch type of configuration for alarm unit 64 where the user turns the alarm unit 64 on to activate the shrill sound, it is strongly preferred that purse 10 have an automatic activating mechanism 68 that immediately activates the alarm when it is engaged. In the preferred embodiment, the activating mechanism 68 is associated with handle 34 such that pulling hard on handle 34, such as strap member 36, will activate the alarm unit 64. In a preferred embodiment, the activating mechanism 68 is incorporated into the connections between the handle 34 and purse body 12, as shown in FIGS. 1 through 3. Although it may be sufficient if only one end 38/40 of the strap member 36, as handle 34, to include the activating mechanism 68, it is preferred that both ends 38/40 of strap member 36 comprise activating mechanism 68 so that the alarm unit 64 is more likely to activate in case of an attempt to snatch the purse 10 and to make it easier for the user to activate alarm unit 64 himself or herself in case of emergency (i.e., not have to fumble around for the appropriate end). Activating mechanism 68 can be configured in much the same manner as many of the portable alarms, which are readily available in the prior art, that have removable pins or the like which activate the alarm when the pin is removed. In a preferred embodiment, the activating mechanism 68 has a pair of connectors 70 that operate together to activate the alarm unit 64 when they are pulled apart, as shown in FIG. 5. One of connectors 70 will be attached to an end, such as second end 40, of strap member 36 and the other connector 70 will be connected to purse body 12, either directly or by way of an outwardly extending tab 72 that is connected to purse body 12. When the connectors 70 are joined the alarm unit 64 is quiet and when the connectors 70 are pulled apart the alarm unit 64 activates is high pitch, loud alarm. As will be readily apparent to those skilled in the art, the activating mechanism 68 must be configured such that it does not easily come apart and activate the alarm unit 64 in non-emergency situations and it must be configured that a only a reasonable amount of force is necessary to cause the alarm unit 64 to activate such that when the handle 34 is pulled on, such as during an attempted snatch of purse 10, it will pull apart the activating mechanism 68 and activate alarm unit 64.

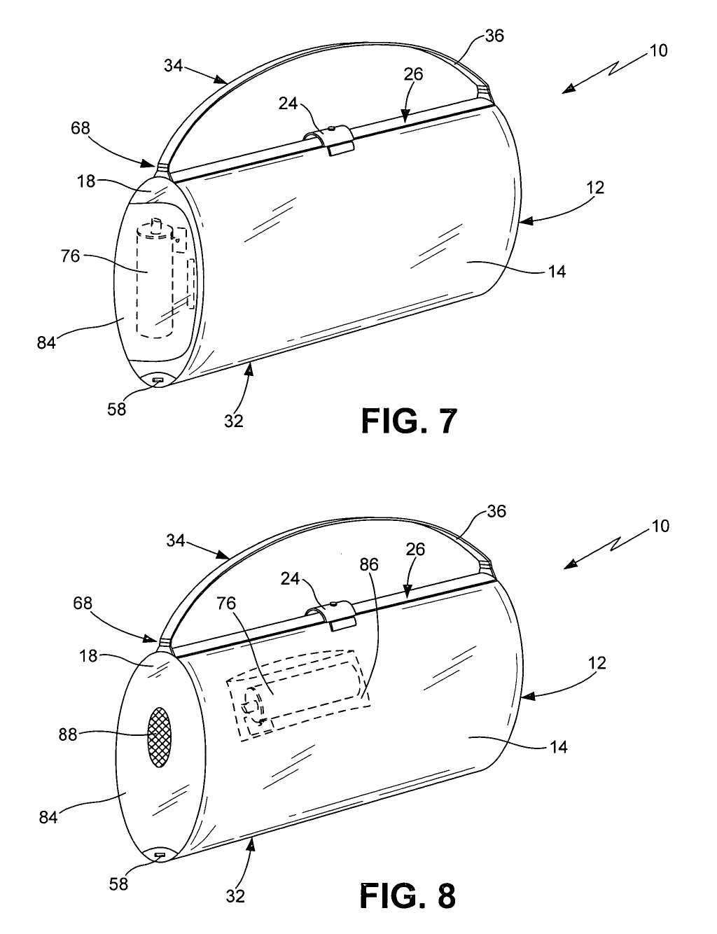

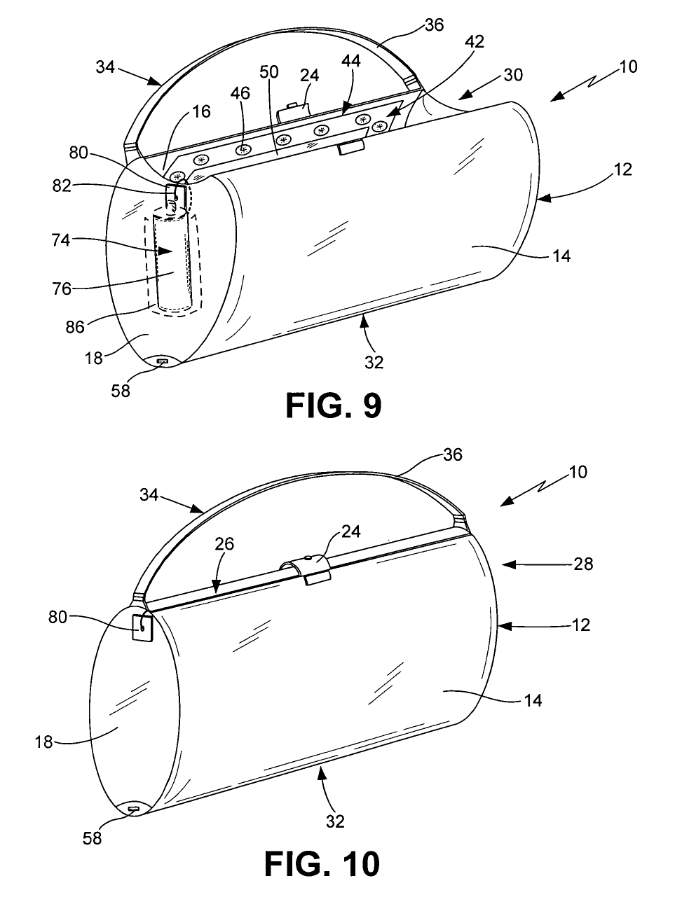

To provide additional security for the user of purse 10, the preferred embodiment of purse 10 also comprises a safety device mechanism 74 that is configured to retain a personal safety device 10, such as described above, and allow the user to easily retrieve and utilize, as shown in FIG. 6, the personal safety device 76. In a preferred embodiment, safety device mechanism 74 comprises a pouch unit 78 sized and configured to securely hold the personal safety device 76 and a retractable securing mechanism 80 configured to hold the pouch unit 78, with safety device mechanism 74 therein, tightly against the purse body 12. In the embodiment shown in FIG. 7, retractable securing mechanism 80 positions pouch unit 78 at the first end 18 of purse body 12. As will be readily appreciated by those skilled in the art, securing mechanism 80 can alternatively be positioned at sides 14/16, the second end 20 of purse body 12 or inside purse body 12 (as shown in FIGS. 8, 9 and 10). In a preferred embodiment, securing mechanism 80 is of the type that comprises a retractable wire member 82 that is forcibly pulled inside of securing mechanism 80 when not in use or after use, similar in operation to retractable devices utilized for keys and the like. Preferably, only a reasonable amount of force is necessary to pull the personal safety device 76, in pouch 78, outward from purse 10 so the user can use it as intended. In the embodiment of FIGS. 1 through 3 and 6, the safety device mechanism 74 is positioned outside of purse body 12. In an alternative embodiment, shown in FIG. 7, an easily removable flap member 84 is utilized to cover safety device mechanism 74 so that it is not visible and less likely to be bumped during non-use. In a preferred embodiment, flap member 84 comprises a connecting mechanism, not shown, that allows the user to quickly and easily move flap member 84 out of the way so he or she may use the personal safety device 76. The connecting mechanism can comprise hook and loop material (Velcro®), snap, button, ties and other commonly available devices for releasably joining two components together. In the embodiment of FIGS. 8, 9 and 10, the safety device mechanism 74 is positioned inside purse body 12, such as inside a specially configured pocket 86 inside the interior compartment 22, so that the personal safety device 76 can be stored away from others, particularly children, when it is not needed for self-defense. In the embodiment of FIG. 8, the pocket 86 is near the center of purse 10. In the embodiment of FIGS. 9 and 10, the pocket 86 is located at one of the end walls 18/20 of purse 10. If desired, an attachment mechanism 88, such as Velcro® or other attaching devices, can be positioned on the outside of purse body 12, as shown in FIG. 8, so the user can removably attach pouch 78 to the purse body 12 when he or she is walking or otherwise passing through an area where it would be desired that the personal safety device 76 is more readily accessible than when stored inside the purse body 12. In the embodiment of FIGS. 9 and 10, the securing mechanism 80 is attached to the outside of the purse 10, as shown on first end wall 18, with the wire member extending into the interior compartment 22 to the personal safety device 76, which is stored in pocket 86 when not in needed for protection. In any configuration where the personal safety device 76 is stored inside the purse 10 to limit access to children and other unauthorized users, it is nevertheless important that the safety device mechanism 74 be stored in a manner such that the user is able to quickly and easily access the personal safety device 76 so he or she can use it in case of emergency.

The security light purse 10 of the present invention can include the purse light 42 and either or both of the alarm unit 64 and the safety device mechanism 74. In use, the user of security light purse 10 carries the purse 10 as he or she would normally carry a purse. When he or she desires lighted access to the interior compartment 22, all the user has to do is open the clasp 24 or other open/close mechanism as it would normally be opened. When moved to the open position 30, the light from purse light 42 will automatically come on, allowing the user to better see what is inside compartment 22. When the purse 10 is placed in its closed position 28, the light from purse light 42 will go off. The user only needs to periodically recharge the batteries 54 inside battery compartment 56, preferably by using a power cord connected to recharge port 58. If desired, the purse 10 can be configured so the user can partially or completely remove purse light 42 from purse 10, if desired, to shine the light therefrom on an object outside of purse 10. In addition, the purse 10 can also be configured so the user can move purse light 42 from one purse to another. If someone attempts to snatch the purse 10, the handle 34 will disconnect from purse body 12 to activate alarm unit 64 and a loud alarm will sound. Typically, the purse snatcher will not want to run or otherwise attempt to get away with purse 10 while it is making a high pitch alarm sound and, therefore, he or she will likely toss the purse 10 to the ground so that the user may be able to retrieve it. If the user feels threatened by another person or an animal, such as an unfriendly dog, the user can quickly and easily access and place into position a personal safety device 76, that is held into position on or in purse 10 by the safety device mechanism 74. By pulling on the pouch 78 the user will withdraw the wire member 82 from securing mechanism 80 and be able to hold the personal safety device 76 in a useable position. By releasing or reducing the force on the personal safety device 76, the pouch 78 will be pulled back into its rest position.

While there are shown and described herein specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to various modification with regard to any dimensional relationships set forth herein and modifications in assembly, materials, size, shape and use. For instance, there are numerous components described herein that can be replaced with equivalent functioning components to accomplish the objectives of the present invention.

What is claimed is:

1. A security light purse, comprising:
a purse body having a plurality of walls defining an interior compartment inside said purse body;
an open/close mechanism on said purse body configured to selectively place said purse body in a closed position enclosing said interior compartment or an open position allowing access to said interior compartment; and
a purse light inside said interior compartment, said purse light having one or more sources of light disposed on a light panel, said sources of light connected to a source of electrical power, said source of electrical power operatively connected to said open/close mechanism so as to emit light from said sources of light when said purse body is in said open position and turn off said sources of light when said purse body is in said closed position.

2. The purse according to claim 1, wherein said light panel is sufficiently flexible so as to be shaped to the configuration of one of said plurality of walls.

3. The purse according to claim 1, wherein said sources of light comprise LEDs.

4. The purse according to claim 1, wherein said source of electrical power comprises one or more batteries.

5. The purse according to claim 4, wherein said batteries are disposed inside a battery compartment inside said purse body.

6. The purse according to claim 4, wherein said purse further comprises a recharge port operatively connected to said batteries.

7. The purse according to claim 1, wherein said purse light is removably disposed inside said interior compartment.

8. The purse according to claim 1, wherein said purse light is fixedly disposed inside said interior compartment.

9. The purse according to claim 1 further comprising an alarm unit disposed in said purse body, said alarm unit configured to activate when said purse is snatched.

10. The purse according to claim 9, wherein said alarm unit is operatively connected to an activating mechanism associated with a handle attached to said purse body, said activating mechanism configured to activate said alarm unit upon disconnection of one or more ends of said handle from said purse body.

11. The purse according to claim 10, wherein said activating mechanism comprises one or more connectors configured to releasably interconnect said handle and said purse body.

12. The purse according to claim 9 further comprising a safety device mechanism having a personal safety device, said safety device mechanism configured to securely hold said personal safety device in position for use thereof.

13. The purse according to claim 12, wherein said safety device mechanism comprises a pouch attached to a retractable securing mechanism, said personal safety device disposed in said pouch.

14. The purse according to claim 1 further comprising a safety device mechanism having a personal safety device, said safety device mechanism attached to said purse body and configured to securely hold said personal safety device in position for use thereof.

15. The purse according to claim 14, wherein said safety device mechanism comprises a pouch attached to a retractable securing mechanism, said personal safety device disposed in said pouch.

16. A security light purse, comprising:
a purse body having a plurality of walls defining an interior compartment inside said purse body;
a handle attached to said purse body;
an open/close mechanism on said purse body configured to selectively place said purse body in a closed position enclosing said interior compartment or an open position allowing access to said interior compartment;
one or more batteries disposed inside a battery compartment inside said purse body;
a purse light inside said interior compartment, said purse light having one or more sources of light disposed on a light panel, said sources of light connected to said one or more batteries, said batteries operatively connected to said open/close mechanism so as to emit light from said sources of light when said purse body is in said open position and turn off said sources of light when said purse body is in said closed position; and
an alarm unit disposed in said purse body, said alarm unit operatively connected to an activating mechanism associated with said handle and to said one or more batteries, said activating mechanism configured to activate said alarm unit upon disconnection of one or more ends of said handle from said purse body.

17. The purse according to claim 16, wherein said light panel is sufficiently flexible so as to be shaped to the configuration of one of said plurality of walls.

18. The purse according to claim 16 further comprising a safety device mechanism having a personal safety device, said safety device mechanism configured to securely hold said personal safety device in position for use thereof.

19. A security light purse, comprising:
a purse body having a plurality of walls defining an interior compartment inside said purse body;
a handle attached to said purse body;
an open/close mechanism on said purse body configured to selectively place said purse body in a closed position enclosing said interior compartment or an open position allowing access to said interior compartment;
one or more batteries disposed inside a battery compartment inside said purse body;
a purse light inside said interior compartment, said purse light having one or more sources of light disposed on a light panel, said sources of light connected to said one or more batteries, said batteries operatively connected to said open/close mechanism so as to emit light from said sources of light when said purse body is in said open position and turn off said sources of light when said purse body is in said closed position; and
a safety device mechanism having a personal safety device, said safety device mechanism attached to said purse body and configured to securely hold said personal safety device in position for use thereof, said safety device mechanism having a pouch attached to a retractable securing mechanism, said personal safety device disposed in said pouch.

20. The purse according to claim 19 further comprising an alarm unit disposed in said purse body, said alarm unit operatively connected to an activating mechanism associated with said handle and to said one or more batteries, said activating mechanism configured to activate said alarm unit upon disconnection of one or more ends of said handle from said purse body.
